(19) United States
(12) Patent Application Publication
(10) Pub. No.: US 2024/0128700 A1
(43) Pub. Date: Apr. 18, 2024

(54) Wire Guide System for Hand Tools

(71) Applicant: Odyssey Tool, LLC, Clinton Township, MI (US)

(72) Inventor: Douglas A. Particka, Snover, MI (US)

(21) Appl. No.: 18/483,852

(22) Filed: Oct. 10, 2023

Related U.S. Application Data
(60) Provisional application No. 63/379,349, filed on Oct. 13, 2022.

(51) Int. Cl. H01R 43/042

(52) U.S. Cl. CPC H01R 43/042

(57) ABSTRACT

A system for attaching electrical terminals to wires includes a wire guide cassette removably affixed to a crimping tool, the wire guide cassette movable between at least a closed position and an open position, wherein in the open position, an end terminal may be inserted through a wire guide orifice and into the crimping tool. In the closed position, a wire may be inserted into the wire guide orifice and into the end terminal. The wire guide cassette locates and aligns the wire for insertion into the end terminal in the closed position, wherein the crimping tool may then be used to crimp the end terminal onto the wire. The wire guide cassette may then be opened, and the wire and end terminal crimped to the wire may be removed from the wire guide cassette and tool.

### INTRODUCTION

The present disclosure relates to wire crimping tools, and more specifically, to hand tools for attaching electrical terminals to wire. Electrical terminals are commonly provided on a reel attached to a tape or carrier strip which positions successive terminals at a predefined, equal spacing. The die commonly includes a feed platen or plate which receives the carrier strip and aligns each terminal with a tool portion. The crimping tool portion commonly includes an insulation stripper, first and second crimp tools, and first and second anvils each vertically aligned under one of the first or second crimp tools. An incremental terminal feeding member such as a feed finger can also be used to incrementally feed a next-in-line terminal from the feed platen to the crimping tool portion with each stroke of a ram provided with the press.

A first connection is commonly created by the first crimp tool and first anvil by crimping the terminal and a stripped wire portion. A second connection is created by the second crimp tool and second anvil by crimping tabs of the terminal about an insulated portion of the wire proximate to the stripped wire portion. Each type and size of terminal commonly requires a separate feed platen or adjustment of an alignment portion of the feed platen to properly align the terminals with the crimping tool portion. Each type and size of terminal also requires a different tool portion. To eliminate the need to separately install a new feed platen, and tool portion, and then align and test these components, terminal installers commonly remove and replace the entire die, feed platen, and tool portion together when changing an assembly line from a first to a second size or type of terminal. This requires not only multiple feed platens and tool portions, but also multiple dies, and therefore increased hardware costs for the multiple dies and die attached components. Each die change, or combined feed platen adjustment and tool portion change can require approximately 30 to 60 minutes for a machine operator to perform, not including fine-adjustment time required to ensure proper alignment between the crimp tools and anvils. This down-time is nonproductive and therefore decreases efficiency while increasing per-part costs.

Accordingly, while current systems and methods for attaching electrical terminals to wire achieve their intended purpose, there is a need for a new and improved system and method for attaching electrical terminals to wire that is portable, operated by hand, and which allows for rapid feed and tool portion changes that maintain proper alignment between the electrical terminals and the wire ends without sacrificing productivity and efficiency, and which decrease per-part costs.

### SUMMARY

According to several aspects of the present disclosure, a system for attaching electrical terminals to wires includes a wire guide cassette and a crimping tool. The wire guide cassette is removably mounted to the crimping tool. The wire guide cassette is movable between at least a closed position and an open position displaced from the closed position. The wire guide cassette is movable independent from crimping actuation of the crimping tool. A wire inserted into the wire guide cassette in the closed position is located and guided into an end terminal held in the crimping tool, and the crimping tool is actuated to crimp the end terminal onto a stripped end of the wire. In the open position, the wire and end terminal are freely movable relative to and removable from the wire guide cassette and crimping tool.

In another aspect of the present disclosure the wire guide cassette further includes a mounting plate affixed coaxially to the crimping tool by one or more mounting plate fasteners and a lower lift plate coaxially disposed overtop the mounting plate opposite the crimping tool. The wire guide cassette further includes one or more bearings disposed in ramps formed in the lower lift plate opposite the crimping tool and a bearing retainer plate disposed overtop and coaxially located with the lower lift plate and the mounting plate, the bearing retainer plate movably retaining the one or more bearings. A lower carriage plate is coaxially disposed overtop the bearing retainer plate, and a plurality of wire guide portions are disposed overtop the bearing retainer plate. The plurality of wire guide portions define a wire guide cone tip extending coaxially through each of the lower carriage plate, the bearing retainer plate, the lower lift plate, the mounting plate, and into the crimping tool. The wire guide cassette further includes an upper carriage plate disposed overtop the plurality of wire guide portions, and located coaxially with the lower carriage plate, the bearing retainer plate, the lower lift plate, the mounting plate, and the crimping tool. A washer is disposed coaxially overtop the upper carriage plate, and a cover plate is disposed coaxially overtop the upper carriage plate and secured to the upper carriage plate, the lower carriage plate, the bearing retainer plate, the lower lift plate and the mounting plate with one or more cover plate fasteners. An activation ring circumferentially surrounds at least the bearing retainer plate, the lower carriage plate, the one or more wire guide portions, and the upper carriage plate. The activation ring is locked for rotational movement in concert with the bearing retainer plate. As the activation ring is moved from the closed position to the open position, the activation ring causes rotational and axial movement of the bearing retainer plate, the lower carriage plate, the one or more wire guide portions, and the upper carriage plate relative to the mounting plate and the crimping tool. The axial movement defines an increase in axial distance between the bearing retainer plate, the lower carriage plate, the one or more wire guide portions, and the upper carriage plate and the mounting plate and crimping tool.

In yet another aspect of the present disclosure the one or more bearings are ball bearings, and the ramps formed in the lower lift plate are substantially tear-drop shaped depressions having a variable depth which decreases from a substantially circular head to a pointed tail of the ramp. The heads and tails of the ramps are circumferentially-disposed at equidistant locations about an outer surface of the lower lift plate. The outer surface of the lower lift plate faces away from the mounting plate and the crimping tool. The bearing retainer plate is disposed overtop the lower lift plate and movably retains the one or more bearings at the equidistant locations. The lower carriage plate has a plurality of mirrored ramps are formed on an inner side of the lower carriage plate at substantially identical circumferential positions as the ramps formed in the lower lift plate and bearing retainers formed through the bearing retainer plate. The inner side of the lower carriage plate faces towards the mounting plate and the crimping tool. The mirrored ramps define substantially tear-drop shaped depressions having a variable depth which decreases from a substantially circular “head” to a pointed “tail” of the mirrored ramp. The mirrored bearing ramps are oriented opposite the ramps such that the heads and tails of the ramps extend in circumferentially opposite directions to the heads and tails of the mirrored ramps.

In still another aspect of the present disclosure the ramps and mirrored ramps have a maximum depth at the heads of the ramps and mirrored ramps, and a minimum depth, smaller than the maximum depth, at the tails of the ramps and mirrored ramps.

In yet another aspect of the present disclosure as the activation ring is moved from the closed position to the open position, rotational movement of the activation ring causes rotational movement of the bearing retainer plate which thereby causes the bearings to ride within the ramps and mirrored ramps from the heads of the ramps and mirrored ramps to the tails of the ramps and mirrored ramps, thereby increasing an axial distance between the lower carriage plate and the lower lift plate from a minimum distance to a maximum distance larger than the minimum distance. The maximum distance is substantially identical to a diameter of the ball bearings.

In still another aspect of the present disclosure the plurality of wire guide portions further include a first wire guide portion and a second wire guide portion identical to the first wire guide portion. Each of the first and second wire guide portions are rotatably attached to the upper and lower carriage plates by dowels extending from the lower carriage plate through the first and second wire guide portions and into the upper carriage plate. The first wire guide portion has a first diametric face, and the second wire guide portions has a second diametric face. In the closed position, the first and second diametric faces are in contact with one another.

In yet another aspect of the present disclosure the wire guide cassette further includes one or more return springs, the one or more return springs biasing the first and second diametric faces into contact with one another.

In still another aspect of the present disclosure each of the one or more return springs is in contact with and extends from an outer spring seat formed as an axial protrusion on the lower carriage plate to an inner spring seat formed on each of the first and second wire guide portions.

In yet another aspect of the present disclosure the washer biases the cover plate against the upper carriage plate and provides a compacting force that secures all component parts of the wire guide cassette against one another within the activation ring and against the crimping tool.

In still another aspect of the present disclosure the washer is formed of spring steel and defines a wave washer.

In yet another aspect of the present disclosure a wire guide system for hand tools, includes a wire guide cassette and a crimping tool. A mounting plate of the wire guide cassette is removably and coaxially affixed to the crimping tool by one or more mounting plate fasteners. The wire guide cassette further includes a lower lift plate coaxially disposed overtop the mounting plate opposite the crimping tool. One or more bearings is/are disposed in ramps formed in the lower lift plate opposite the crimping tool. A bearing retainer plate is disposed overtop and coaxially located with the lower lift plate and the mounting plate. The bearing retainer plate movably retains the one or more bearings. A lower carriage plate is coaxially disposed overtop the bearing retainer plate. A plurality of wire guide portions is disposed overtop the bearing retainer plate. The plurality of wire guide portions defines a wire guide cone tip extending coaxially through each of the lower carriage plate, the bearing retainer plate, the lower lift plate, the mounting plate, and into the crimping tool. An upper carriage plate is disposed overtop the plurality of wire guide portions, and located coaxially with the lower carriage plate, the bearing retainer plate, the lower lift plate, the mounting plate, and the crimping tool. A washer is disposed coaxially overtop the upper carriage plate, and a cover plate is disposed coaxially overtop the upper carriage plate and secured to the upper carriage plate, the lower carriage plate, the bearing retainer plate, the lower lift plate and the mounting plate with one or more cover plate fasteners. An activation ring circumferentially surrounds at least the bearing retainer plate, the lower carriage plate, the one or more wire guide portions, and the upper carriage plate. The activation ring is locked for rotational movement in concert with the bearing retainer plate. Accordingly, as the activation ring is moved from a closed position to an open position, the activation ring causes rotational and axial movement of the bearing retainer plate, the lower carriage plate, the one or more wire guide portions, and the upper carriage plate relative to the mounting plate and the crimping tool. The axial movement defines an increase in axial distance between the bearing retainer plate, the lower carriage plate, the one or more wire guide portions, and the upper carriage plate and the mounting plate and crimping tool. The wire guide cassette is movable, via the actuation ring, independent from crimping actuation of the crimping tool. A wire inserted into the wire guide cassette in the closed position is located and guided into an end terminal held in the crimping tool, and the crimping tool is actuated to crimp the end terminal onto a stripped end of the wire. In the open position, the wire and end terminal are freely movable relative to and removable from the wire guide cassette and crimping tool.

In still another aspect of the present disclosure the one or more bearings are ball bearings. The ramps formed in the lower lift plate are substantially tear-drop shaped depressions having a variable depth which decreases from a substantially circular head to a pointed tail of the ramp. The heads and tails of the ramps are circumferentially-disposed at equidistant locations about an outer surface of the lower lift plate. The outer surface of the lower lift plate faces away from the mounting plate and the crimping tool. The bearing retainer plate is disposed overtop the lower lift plate and movably retains the one or more bearings at the equidistant locations. The lower carriage plate has a plurality of mirrored ramps are formed on an inner side of the lower carriage plate at substantially identical circumferential positions as the ramps formed in the lower lift plate and bearing retainers formed through the bearing retainer plate. The inner side of the lower carriage plate faces towards the mounting plate and the crimping tool. The mirrored ramps define substantially tear-drop shaped depressions having a variable depth which decreases from a substantially circular “head” to a pointed “tail” of the mirrored ramp. The mirrored bearing ramps are oriented opposite the ramps such that the heads and tails of the ramps extend in circumferentially opposite directions to the heads and tails of the mirrored ramps. The ramps and mirrored ramps have a maximum depth at the heads of the ramps and mirrored ramps, and a minimum depth, smaller than the maximum depth, at the tails of the ramps and mirrored ramps.

In yet another aspect of the present disclosure as the activation ring is moved from the closed position to the open position, rotational movement of the activation ring causes rotational movement of the bearing retainer plate which thereby causes the bearings to ride within the ramps and mirrored ramps from the heads of the ramps and mirrored ramps to the tails of the ramps and mirrored ramps, thereby increasing an axial distance between the lower carriage plate and the lower lift plate from a minimum distance to a maximum distance larger than the minimum distance. The maximum distance is substantially identical to a diameter of the ball bearings.

In still another aspect of the present disclosure the plurality of wire guide portions further includes a first wire guide portion and a second wire guide portion identical to the first wire guide portion. Each of the first and second wire guide portions are rotatably attached to the upper and lower carriage plates by dowels extending from the lower carriage plate through the first and second wire guide portions and into the upper carriage plate. The first wire guide portion has a first diametric face, and the second wire guide portions has a second diametric face. In the closed position, the first and second diametric faces are in contact with one another.

In yet another aspect of the present disclosure the wire guide cassette further includes one or more return springs. The one or more return springs bias the first and second diametric faces into contact with one another so that wires inserted into the wire guide cassette in the closed position are located and guided into the end terminal held in the crimping tool.

In still another aspect of the present disclosure each of the one or more return springs is in contact with and extends from an outer spring seat formed as an axial protrusion on the lower carriage plate to an inner spring seat formed on each of the first and second wire guide portions.

In yet another aspect of the present disclosure the washer biases the cover plate against the upper carriage plate, and provides a compacting force that secures all component parts of the wire guide cassette against one another within the activation ring and against the crimping tool.

In still another aspect of the present disclosure a method for attaching electrical terminals to wires includes removably mounting a wire guide cassette onto a crimping tool. The wire guide cassette is movable between at least a closed position and an open position displaced from the closed position. The wire guide cassette is movable independently from crimping actuation of the crimping tool. The method further includes inserting a wire into the wire guide cassette in the closed position. In the closed position the wire is located and guided into an end terminal held in the crimping tool. The method further includes actuating the crimping tool to crimp the end terminal onto a stripped end of the wire and moving the wire guide cassette to the open position. In the open position the wire and end terminal are freely movable relative to and removable from the wire guide cassette and crimping tool.

In yet another aspect of the present disclosure removably mounting the wire guide cassette onto the crimping tool further includes coaxially affixing a mounting plate of the wire guide cassette to the crimping tool with one or more mounting plate fasteners. The wire guide cassette including a lower lift plate coaxially disposed overtop the mounting plate opposite the crimping tool and one or more bearings disposed in ramps formed in the lower lift plate opposite the crimping tool. The one or more bearings are ball bearings. The ramps formed in the lower lift plate are substantially tear-drop shaped depressions having a variable depth which decreases from a substantially circular head to a pointed tail of the ramp, wherein the heads and tails of the ramps are circumferentially-disposed at equidistant locations about an outer surface of the lower lift plate. The outer surface of the lower lift plate faces away from the mounting plate and the crimping tool. A bearing retainer plate disposed overtop and coaxially located with the lower lift plate and the mounting plate, the bearing retainer plate movably retaining the one or more bearings. A lower carriage plate is coaxially disposed overtop the bearing retainer plate. A plurality of mirrored ramps are formed on an inner side of the lower carriage plate at substantially identical circumferential positions as the ramps formed in the lower lift plate and bearing retainers formed through the bearing retainer plate. The inner side of the lower carriage plate faces towards the mounting plate and the crimping tool. The mirrored ramps define substantially tear-drop shaped depressions having a variable depth which decreases from a substantially circular “head” to a pointed “tail” of the mirrored ramp. The mirrored bearing ramps are oriented opposite the ramps such that the heads and tails of the ramps extend in circumferentially opposite directions to the heads and tails of the mirrored ramps. The ramps and mirrored ramps have a maximum depth at the heads of the ramps and mirrored ramps, and a minimum depth, smaller than the maximum depth, at the tails of the ramps and mirrored ramps. A first wire guide portion and a second wire guide portion identical to the first wire guide portion, the first and second wire guide portions disposed overtop the bearing retainer plate, the first and second wire guide portions defining a wire guide cone tip extending coaxially through each of the lower carriage plate, the bearing retainer plate, the lower lift plate, the mounting plate, and into the crimping tool. An upper carriage plate is disposed overtop the first and second wire guide portions, and located coaxially with the lower carriage plate, the bearing retainer plate, the lower lift plate, the mounting plate, and the crimping tool. Each of the first and second wire guide portions are rotatably attached to the upper and lower carriage plates by dowels extending from the lower carriage plate through the first and second wire guide portions and into the upper carriage plate. The first wire guide portion has a first diametric face, and the second wire guide portion has a second diametric face. In the closed position, the first and second diametric faces are in contact with one another. A washer is disposed coaxially overtop the upper carriage plate. A cover plate is disposed coaxially overtop the upper carriage plate and secured to the upper carriage plate, the lower carriage plate, the bearing retainer plate, the lower lift plate and the mounting plate with one or more cover plate fasteners. An activation ring circumferentially surrounds at least the bearing retainer plate, the lower carriage plate, the one or more wire guide portions, and the upper carriage plate. The activation ring is locked for rotational movement in concert with the bearing retainer plate. The wire guide cassette further includes one or more return springs. Each of the one or more return springs is in contact with and extends from an outer spring seat formed as an axial protrusion on the lower carriage plate to an inner spring seat formed on each of the first and second wire guide portions. The method further includes causing, by moving the activation ring, rotational movement of the bearing retainer plate and in turn, causing the bearings to ride within the ramps and mirrored ramps from the heads of the ramps and mirrored ramps to the tails of the ramps and mirrored ramps, thereby increasing an axial distance between the lower carriage plate and the lower lift plate from a minimum distance to a maximum distance larger than the minimum distance. The maximum distance is substantially identical to a diameter of the ball bearings. Moving the activation ring from the closed position to the open position causes rotational and axial movement of the bearing retainer plate, the lower carriage plate, the one or more wire guide portions, and the upper carriage plate relative to the mounting plate and the crimping tool. The axial movement defines an increase in axial distance between the bearing retainer plate, the lower carriage plate, the one or more wire guide portions, and the upper carriage plate and the mounting plate and crimping tool.

In still another aspect of the present disclosure the method further includes biasing, via the one or more return springs, the first and second diametric faces into contact with one another, and biasing, via the washer, the cover plate against the upper carriage plate. The washer providing a compacting force that secures all component parts of the wire guide cassette against one another within the activation ring and against the crimping tool.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an environmental view depicting a wire guide system for hand tools according to an exemplary embodiment;

FIG. 2A is a perspective exploded diagram of a portion of the wire guide system for hand tools of FIG. 1 according to an exemplary embodiment;

FIG. 2B is an exploded diagram of a portion of the wire guide system for hand tools of FIG. 2A depicting a wire and an end terminal to be crimped onto said wire according to an exemplary embodiment;

FIG. 2C is a perspective outer view of a portion of the wire guide system for hand tools of FIG. 2A depicting multiple wire guide portions according to an exemplary embodiment;

FIG. 2D is a perspective outer side view of the fully assembled portion of the wire guide system for hand tools of FIGS. 2A-2C according to an exemplary embodiment;

FIG. 3A is a perspective cutaway top view of a portion of the wire guide system for hand tools of FIG. 1 in a closed position according to an exemplary embodiment;

FIG. 3B is a perspective cutaway end view of a portion of the wire guide system for hand tools of FIG. 3A in the closed according to an exemplary embodiment;

FIG. 3C is a perspective outer end view of a portion of the wire guide system for hand tools of FIG. 3A in the closed position according to an exemplary embodiment;

FIG. 3D is a perspective inner end view of a portion of the wire guide system for hand tools of FIG. 3A in the closed according to an exemplary embodiment;

FIG. 4A is a perspective cutaway top view of a portion of the wire guide system for hand tools of FIG. 1 in an open position according to an exemplary embodiment;

FIG. 4B is a perspective cutaway end view of a portion of the wire guide system for hand tools of FIG. 4A in the open according to an exemplary embodiment;

FIG. 4C is a perspective outer end view of a portion of the wire guide system for hand tools of FIG. 4A in the open position according to an exemplary embodiment; and

FIG. 4D is a perspective inner end view of a portion of the wire guide system for hand tools of FIG. 4A in the open according to an exemplary embodiment.

### DETAILED DESCRIPTION

The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

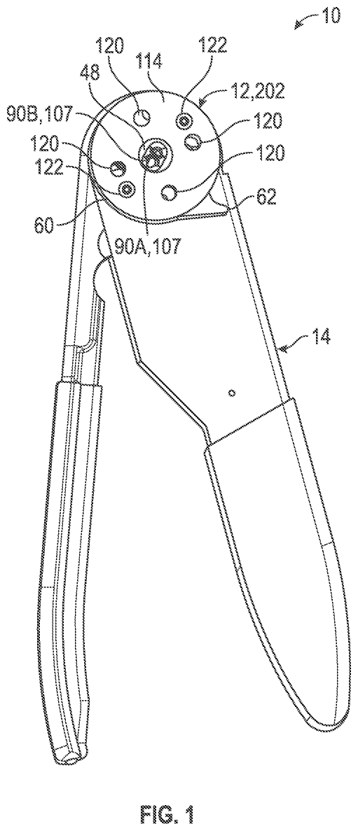

Referring to FIG. 1, a wire guide system 10 for hand tools is shown. The wire guide system 10 includes a releasably connected wire guide cassette 12 which may be a releasably connected to a crimping tool 14. The crimping tool 14 may be any of a variety of devices, including hand tools such as the Daniels DMC AF8, or other such crimping tools. The wire guide cassette 12 includes a plurality of interconnected subcomponents which will be described in further detail herein.

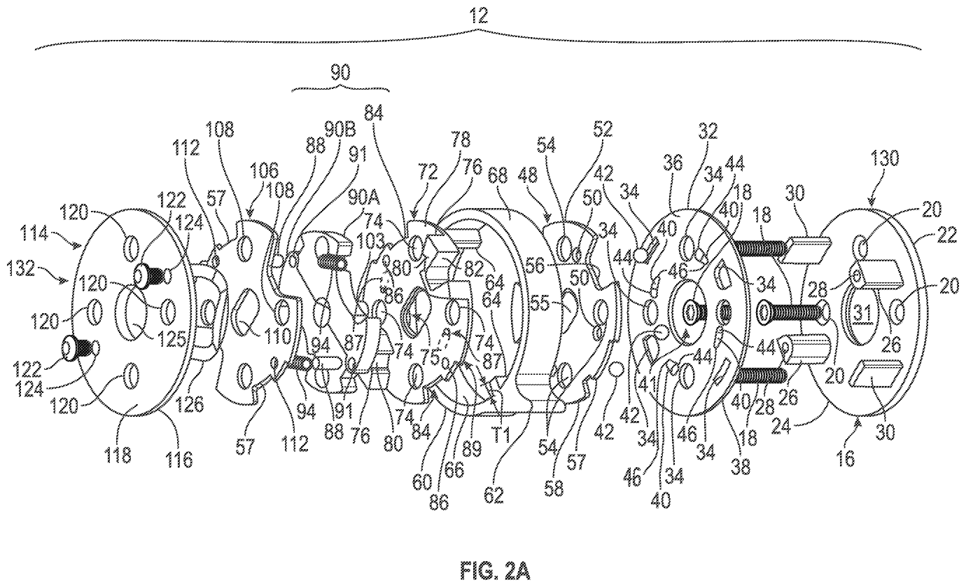

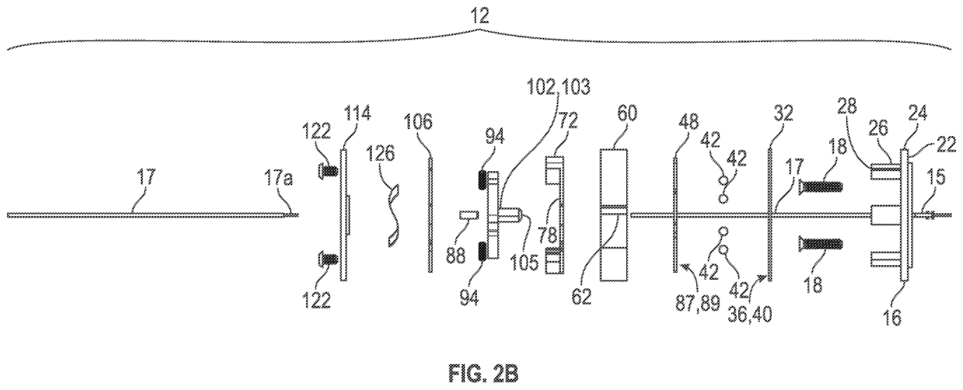

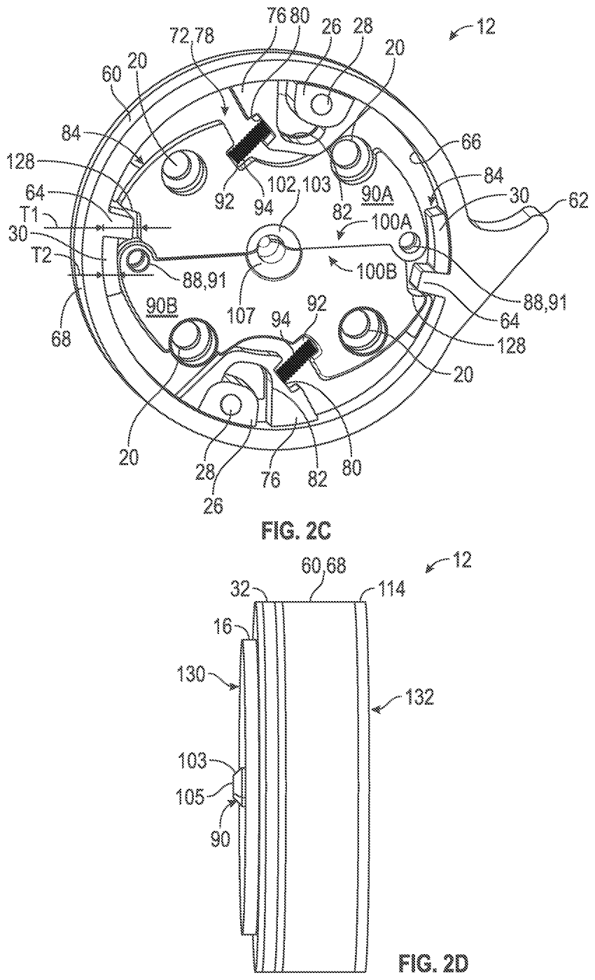

Referring now to FIGS. 2A-2D and with continued reference to FIG. 1, the wire guide system 10 and more specifically, the wire guide cassette 12 is shown in further detail. The wire guide system 10 may be used to affix an end terminal 15 to a wire 17. A mounting plate 16 is connected to the crimping tool 14 by one or more fasteners 18 which extend through a plurality of countersunk apertures 20 formed through the mounting plate 16. The mounting plate 16 may be formed of any of a variety of different materials, but in one example is formed of aluminum or an aluminum alloy. The mounting plate 16 defines a substantially planar disk having substantially planar tool-facing side 22, and a substantially planar guide-facing side 24. The countersunk apertures 20 extend through the mounting plate 16 from the guide-facing side 24 to the crimping tool-facing side 22 and are located at locations on the mounting plate 16 that correspond with threaded receiving apertures (not specifically shown) formed in the crimping tool 14. Accordingly, when the fasteners 18 are inserted into the countersunk apertures 20 in the mounting plate 16 and fully engaged in the threaded receiving apertures, the mounting plate 16 is fixedly attached to and compressed against the crimping tool 14. The fasteners 18 may include bolts, screws, nuts, rivets, or other such mechanical fastening means without departing from the scope or intent of the present disclosure. In a specific example, the fasteners 18 are torx screws such as M3 torx screws sized and shaped to engage with threaded receiving apertures (not specifically shown) formed in the crimping tool 14. The fasteners 18 may be formed of any of a variety of different materials, including but not limited to black-oxide coated steel, or the like.

A plurality of stanchions 26 extend substantially perpendicularly from the guide-facing side 24 of the mounting plate 16. The plurality of stanchions 26 include threaded stanchion apertures 28 formed therein. In several aspects, the plurality of stanchions 26 shown in FIGS. 2A, 2B, and 2C are substantially semi-cylindrical in cross-sectional aspect, though it should be appreciated that other cross-sectional shapes may be used without departing from the scope or intent of the present disclosure. One or more locating features 30 extend substantially perpendicularly from the guide-facing side 24 of the mounting plate 16 as well. The locating features 30 shown define pins having a substantially flat, planar, wall-shaped cross-sectional aspects, though as noted above, these locating features 30 may have other cross-sectional shapes without departing from the scope or intent of the present disclosure. A centrally located mounting plate feed orifice 31 is formed through the center of the mounting plate 16.

A substantially planar lower lift plate 32 is layered overtop the guide-facing side 24 of the mounting plate 16. The lower lift plate 32 has a plurality of lower lift plate apertures 34 formed therethrough. Each of the lower lift plate apertures 34 is positioned to correspond with and allow the stanchions 26 and locating features 30 of the mounting plate 16 to engage therein. Further lower lift plate apertures 34 correspond positionally with the countersunk apertures 20 of the mounting plate 16, thereby providing access for the fasteners 18 without needing to separate the lower lift plate 32 from the mounting plate 16. The lower lift plate 32 includes an outer surface 36 which faces away from the crimping tool 14 and an inner surface 38 which faces towards the mounting plate 16 and the crimping tool 14. Like the mounting plate 16, the lower lift plate 32 may be formed of any of a variety of different materials, but in a particular example is formed of aluminum or an aluminum alloy. A plurality of ramps 40 are formed in the outer surface 36 of the lower lift plate 32. A centrally located lower lift plate feed orifice 41 is formed through the center of the lower lift plate 32. The lower lift plate feed orifice 41 is coaxially-located with the mounting plate feed orifice 31.

A plurality of ball bearings 42 are disposed in or on the plurality of ramps 40. In several aspects, the ball bearings 42 are composed of a stainless steel or other such wear- and corrosion-resistant alloy, or other similarly wear-resistant materials. The ramps 40 define substantially tear-drop shaped depressions having a variable depth which decreases from a substantially circular “head” 44 to a pointed “tail” 46 of the ramp 40. The heads 44 and tails 46 of the ramps 40 are circumferentially-disposed equidistant about the outer surface 36 of the lower lift plate 32.

A substantially planar bearing retainer plate 48 is disposed overtop the plurality of ball bearings 42 and includes a plurality of bearing retainers 50 formed therein. In several aspects, the bearing retainer plate 48 may be formed of stainless steel or other such wear- and corrosion-resistant alloy, or other similarly wear-resistant materials. The bearing retainers 50 are substantially circular apertures formed through a tool-facing surface 52 of the bearing retainer plate 48. The bearing retainers 50 are disposed at locations on the crimping tool-facing surface 52 that correspond with the ramps 40 formed in the outer surface 36 of the lower lift plate 32. In addition to the bearing retainers 50, the bearing retainer plate 48 includes a plurality of retainer plate apertures 54 corresponding in size and location with the lower lift plate apertures 34, the stanchions 26 and locating features 30 of the mounting plate 16, and the countersunk apertures 20 of the mounting plate 16, thereby providing access for the fasteners 18 without needing to separate the bearing retainer plate 48 from the lower lift plate 32 and/or from the mounting plate 16. A centrally located bearing retainer plate feed orifice 55 is formed through the center of the bearing retainer plate 48. The bearing retainer plate feed orifice 55 is coaxially located with the lower lift plate feed orifice 41 and the mounting plate feed orifice 31.

The bearing retainer plate 48 is also formed with stanchion notches 56 and locating feature notches 57 disposed about an outer perimeter 58 of the bearing retainer plate 48. The stanchion notches 56 are located about the outer perimeter 58 of the bearing retainer plate 48 in locations that correspond with the stanchions 26 of the mounting plate 16. Likewise, the locating feature notches 57 are located about the outer perimeter 58 of the bearing retainer plate 48 in locations that correspond to the locating features 30 of the mounting plate 16. However, as will be described in further detail below, when the wire guide cassette 12 is fully assembled and in operation, the bearing retainer plate 48 rotatably moves relative to the mounting plate 16 and lower lift plate 32 from at least a first position to a second position different than the first position. In order to provide for such movement, the stanchion notches 56 and locating feature notches 57 extend for larger circumferential distances than the circumferential measures of each of the corresponding stanchions 26 and/or locating features 30. Accordingly, the stanchions 26 can move circumferentially within the stanchion notches 56, and the locating features 30 can move circumferentially within the locating feature notches 57.

The bearing retainer plate 48 is disposed within an activation ring 60. The activation ring 60 defines a substantially cylindrical structure having an activation lever 62 and a plurality of internal projections 64. The activation ring 60 may be formed of any of a variety of different materials, but in one example is formed of aluminum or an aluminum alloy. In additional aspects, the internal projections 64 are radially-inward pointing wall-like structures that extend inward from an inner surface 66 of the activation ring 60. The internal projections 64 are sized and shaped to fit into and engage with at least a portion of the locating feature notches 57 of the bearing retainer plate 48. In several aspects, the internal projections 64 extend inward for a distance somewhat larger than a thickness “T2” of the locating features 30 of the mounting plate 16.

The activation lever 62 is a rigid projection extending substantially radially-outward from an outer surface 68 of the activation ring 60. While only a single activation lever 62 is shown in the figures, it should be appreciated that additional activation levers 62 may be present without departing from the scope or intent of the present disclosure. In several aspects, the activation lever 62 is sized and shaped to be manipulated by a human hand, thumb, or finger, or the like. However, it should be appreciated that mechanical means, such as robotic manipulators may be used to operate the activation lever 62 without departing from the scope or intent of the present disclosure.

A lower carriage plate 72 is disposed overtop the bearing retainer plate 48 and the ball bearings 42 and within the activation ring 60. The lower carriage plate 72 may be formed of any of a variety of different materials, but in one example is formed of aluminum or an aluminum alloy. In several aspects, the lower carriage plate 72 is substantially planar and includes a plurality of lower carriage plate apertures 74 corresponding in size and location with the lower lift plate apertures 34, the stanchions 26 and locating features 30 of the mounting plate 16, and the countersunk apertures 20 of the mounting plate 16, thereby providing access for the fasteners 18 without needing to separate the lower carriage plate 72, the bearing retainer plate 48, or the lower lift plate 32 from each other and/or from the mounting plate 16. A centrally located lower carriage plate feed orifice 75 is formed through the center of the lower carriage plate 72. The lower carriage plate feed orifice 75 is coaxially located with the bearing retainer plate feed orifice 55, the lower lift plate feed orifice 41, and the mounting plate feed orifice 31.

A plurality of axial protrusions 76 are formed integrally on an outer side 78 of the lower carriage plate 72. The axial protrusions 76 define outer spring seats 80 as well as defining lower carriage plate stanchion receivers 82 sized and shaped to receive the stanchions 26 and retain said stanchions 26 therein. Likewise, the lower carriage plate 72 is formed with locating feature notches 84 sized and shaped to receive the locating features 30 and retain the locating features 30 therein. The lower carriage plate 72 is further formed with lower dowel receivers 86 sized and shaped to receive dowels 88 extending substantially perpendicular to the lower carriage plate 72. The dowels 88 may be formed of any of a variety of different materials including but not limited to metals, metal alloys, stainless steel, or other such stiff and wear-resistant materials. A plurality of mirrored ramps 87 are formed on an inner side 89 of the lower carriage plate 72. The inner side 89 of the lower carriage plate 72 faces towards the mounting plate 16 and the crimping tool 14. The mirrored ramps 87 are located about define substantially tear-drop shaped depressions having a variable depth which decreases from a substantially circular “head” to a pointed “tail” of the mirrored ramp 87. The heads and tails of the mirrored ramps 87 are circumferentially-disposed about the inner side 89 of the lower carriage plate 72. More specifically, the mirrored ramps 87 are located at substantially identical circumferential positions as the ramps 40 formed in the lower lift plate 32 and the bearing retainers 50 formed through the bearing retainer plate 48. Accordingly, the ball bearings 42 are circumferentially located by the bearing retainers 50 and sandwiched between the outer surface 36 of the lower lift plate 32 and the inner side 89 of the lower carriage plate 72. In several aspects, the mirrored bearing ramps 87 are oriented opposite the ramps 40 such that the heads 44 and tails 46 of the ramps 40 extend in circumferentially opposite directions to the heads and tails of the mirrored ramps 87.

A wire guide 90 is disposed overtop the lower carriage plate 72. The wire guide 90 includes two distinct wire guide portions including a first wire guide portion 90A and a second wire guide portion 90B which are rotatably movable relative to one another and relative to the lower carriage plate 72. Each of the first and second wire guide portions 90A, 90B sized and shaped so that each of the first and second wire guide portions 90A, 90B forms one half of the wire guide 90. The first and second wire guide portions 90A, 90B define substantially planar structures formed of tool steel or similar hardened material chosen to be substantially wear and corrosion resistant. Each of the first and second wire guide portions 90A, 90B is identical to the other. That is, the first wire guide portion 90A is of identical shape and structure to the second wire guide portion 90B. Because each of the first and second wire guide portions 90A, 90B is identical, production costs may be reduced, as a single tooling may be used to produce both halves of the wire guide 90. Each of the first and second wire guide portions 90A, 90B is formed with a pivot aperture 91 sized and shaped to receive the dowels 88. More specifically, the dowels 88 locate and provide axes of rotation for each of the first and second wire guide portions 90A, 90B. Each of the first and second wire guide portions 90A, 90B includes an inner spring seat 92.

A return spring 94 extending from and in contact with the outer spring seat 80 to and in contact with the inner spring seat 92. While the return spring 94 shown in the figures is a coil spring, it should be appreciated that other types of springs may be used instead without departing from the scope or intent of the present disclosure. In several examples, the return spring 94 may be a coil spring, a wave spring, a linear coil, a leaf spring, or any of a variety of other devices that provide spring-biased resistance to movement. More specifically, the return springs 94 bias the first wire guide portion 90A and the second wire guide portion 90B against rotational movement about dowels 88. Together, the return springs 94 bias the first wire guide portion 90A against the second wire guide portion 90B such that a first diametric face 100A of the first wire guide portion 90A and a second diametric face 100B of the second wire guide portions 90B are biased into contact with one another.

Each of the first and second diametric faces 100A, 100B forms half of a wire guide feed orifice 102. The wire guide feed orifice 102 is formed within a wire guide cone tip 103 which extends substantially perpendicularly from the substantially planar wire guide portions 90A, 90B towards and through the mounting plate feed orifice 31 and into the crimping tool 14. In several aspects, the wire guide cone tip 103 is sized and shaped to fit into a concave surface or depression (not specifically shown) formed in the crimping tool 14. The cone tip 103 terminates at a recessed face 105 which is sized and shaped to fit precisely around and against the end terminal 15. Accordingly, the wire guide cone tip 103 is coaxially located with the lower carriage plate feed orifice 75, the bearing retainer plate feed orifice 55, the lower lift plate feed orifice 41, and the mounting plate feed orifice 31. In further aspects, the wire guide feed orifice 102 is beveled on an interior surface 107 such that as the wire 17, shown for example in FIG. 2B, is inserted into the wire guide cassette 12, movement of the wire 17 is channeled into or confined to substantially axial movement towards the end terminal 15 housed within the crimping tool 14 rather than radial, lateral, or rotational movement.

The wire guide 90 is sandwiched between the lower carriage plate 72 and an upper carriage plate 106, and within the activation ring 60. The upper carriage plate 106 is substantially planar and may be formed of any of a variety of different materials, but in one example is formed of aluminum or an aluminum alloy. In several aspects, the upper carriage plate 106 includes a plurality of upper carriage plate apertures 108 corresponding in size and location with the lower carriage plate apertures 74, lower lift plate apertures 34, the stanchions 26 and locating features 30 of the mounting plate 16, and the countersunk apertures 20 of the mounting plate 16, thereby providing access for the fasteners 18 without needing to separate the upper carriage plate 106, lower carriage plate 72, the bearing retainer plate 48, or the lower lift plate 32 from each other and/or from the mounting plate 16. A centrally located upper carriage plate feed orifice 110 is formed through the center of the upper carriage plate 106. The upper carriage plate feed orifice 110 is coaxially located with the lower carriage plate feed orifice 75, the bearing retainer plate feed orifice 55, the lower lift plate feed orifice 41, and the mounting plate feed orifice 31. The upper carriage plate 106 is further formed with upper dowel receivers 112 sized and shaped to receive dowels 88 extending from the lower dowel receivers 86 and through the wire guide 90.

A cover plate 114 is disposed overtop the upper carriage plate 106. In several aspects, the cover plate 114 defines a substantially planar and circular plate having an inner cover plate surface 116 and an outer cover plate surface 118. The inner cover plate surface 116 faces towards the mounting plate 16 while the outer cover plate surface 118 defines an exterior surface of the wire guide cassette 12. In several aspects, the cover plate 114 may be formed of any of a variety of different materials, but in a particular example is formed of aluminum or an aluminum alloy. The cover plate 114 has a plurality of cover plate apertures 120 formed therethrough. In several aspects, the cover plate apertures 120 correspond in size and location with upper carriage plate apertures 108, lower carriage plate apertures 74, lower lift plate apertures 34, the stanchion apertures 28 and the countersunk apertures 20 of the mounting plate 16, thereby providing access for the fasteners 18 without needing to separate the upper carriage plate 106, lower carriage plate 72, the bearing retainer plate 48, or the lower lift plate 32 from each other and/or from the mounting plate 16. Cover plate fasteners 122 extend through plate fastener apertures 124 formed in the cover plate 114 and corresponding in location with and engaging with the stanchion apertures 28 of the stanchions 26 on the mounting plate 16. A centrally located cover plate feed orifice 125 is formed through the center of the cover plate 114. The cover plate feed orifice 125 is coaxially located with the upper carriage plate feed orifice 110, the lower carriage plate feed orifice 75, the bearing retainer plate feed orifice 55, the lower lift plate feed orifice 41, and the mounting plate feed orifice 31.

A washer 126 is disposed between the cover plate 114 and the upper carriage plate 106. In several aspects, the washer 126 may be formed of any of a variety of different materials and may take forms different from those shown in the figures. In the example shown in the figures, the washer 126 takes the form of a wave washer formed of spring steel. It should be appreciated in general, that the washer biases the cover plate 114 against the upper carriage plate 106, thereby providing a compacting force that secures all of the component parts of the wire guide cassette 12 against one another, within the activation ring 60 and against the crimping tool 14.

Referring specifically to FIG. 2C, a partially assembled wire guide cassette 12 is shown in additional detail. The wire guide cassette 12 of FIG. 2C includes the mounting plate 16, the lower lift plate 32, the ball bearings 42 (hidden behind the bearing retainer plate 48), the bearing retainer plate 48, the lower carriage plate 72, and the first and second wire guide portions 90A, 90B all retained by and at least partially disposed within the activation ring 60. The plurality of internal projections 64 is shown engaged with the locating features 30 of the mounting plate 16, as well as activation notches 128 of each of the first and second wire guide portions 90A, 90B. The activation notch 128 is located at substantially opposite ends of the wire guide portions 90A, 90B from the pivot aperture 91. In several aspects, the locating features 30 define end-stops for rotational movement of the activation ring 60 relative to the mounting plate 16. Rotational movement of the activation ring 60 relative to the mounting plate 16 is further limited by the plurality of axial protrusions 76 on the outer side 78 of the lower carriage plate 72.

Referring now specifically to FIG. 2D and with continued reference to FIGS. 1, and 2A-2C, the wire guide cassette 12 is shown in fully assembled form wherein the mounting plate 16 defines a first axial end 130 of the wire guide cassette 12 and the cover plate 114 defines a second axial end 132 opposite the first axial end 130 of the wire guide cassette 12. Further, FIG. 2D depicts the activation ring 60 containing the upper carriage plate 106, the wire guide 90, the lower carriage plate 72, the bearing retainer plate 48, the ball bearings 42, and the lower lift plate 32 therein.

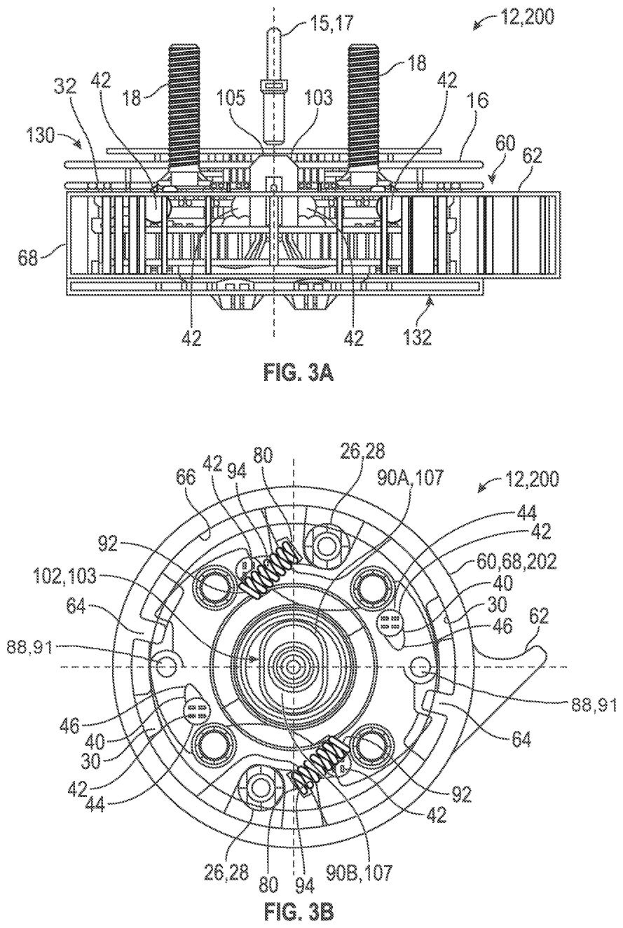

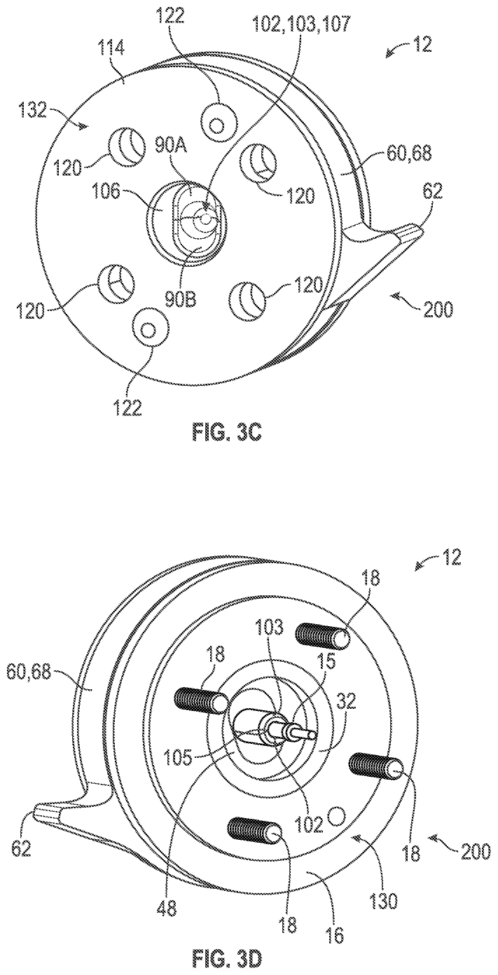

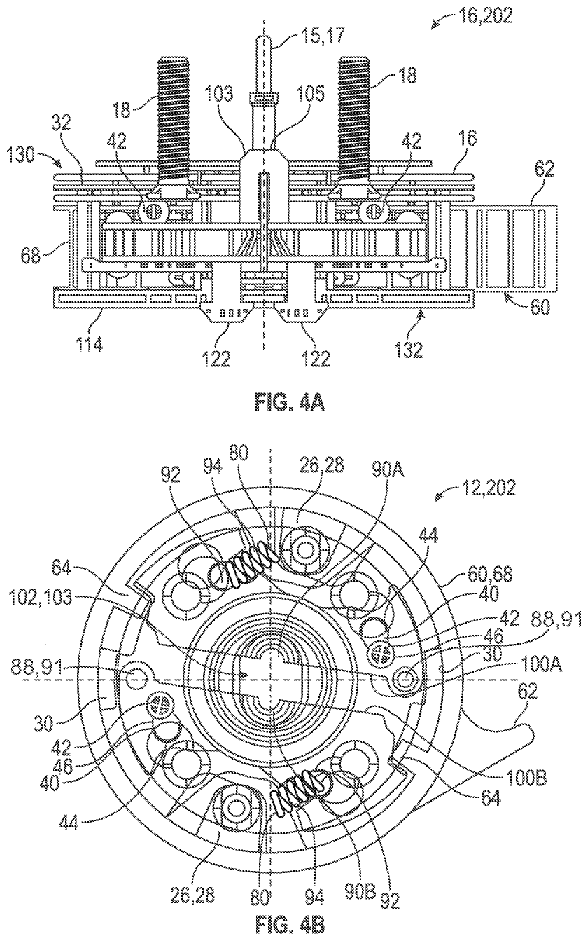

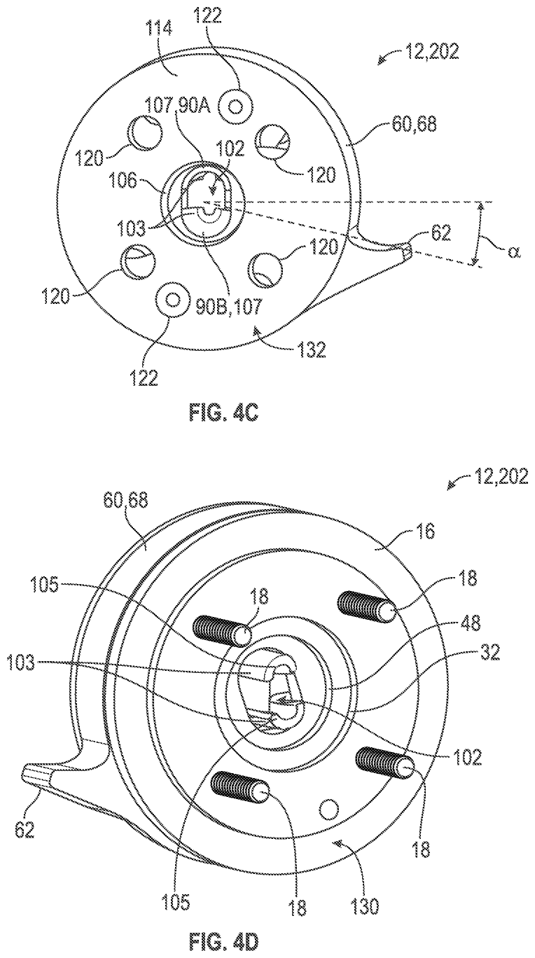

Referring now to FIGS. 3A and 3B and 4A and 4B, and with continuing reference to FIGS. 1-2D the wire guide cassette 12 is shown in several views and in two distinct use positions. Specifically, FIGS. 3A and 3B depict the wire guide cassette 12 in a closed position 200, and FIGS. 4A and 4B depict the wire guide cassette 12 in an open position 202 displaced from and different from the closed position 200. In several aspects, the activation lever 62 may be manually manipulated by a human hand, thumb, or finger, or the like, or by mechanical means from the closed position 200 to the open position 202. As the activation lever 62 is moved, the activation ring 60 rotates relative to the mounting plate 16 and the crimping tool 14. The internal projections 64 engage with the activation notches 128 formed in each of the first and second wire guide portions 90A, 90B and cause the first and second wire guide portions 90A, 90B to rotate against return springs 94 about dowels 88. Rotational movement of the activation ring is limited by engagement of the internal projections 64 in the locating feature notches 57 disposed about the outer perimeter 58 of the bearing retainer plate 48 and similar locating feature notches 57 disposed about the upper carriage plate 106, as well as the locating features 30 of the mounting plate 16. In an example, movement of the activation ring 60 is limited to an activation angle α of about 15° of rotation relative to the mounting plate 16 and crimping tool 14 from the closed position 200 to the open position 202. Additionally, rotational movement of the first and second wire guide portions 90A, 90B is limited by interference between diametric faces 100A, 100B in the closed position 200, and by interference with the axial protrusions 76 of the lower carriage plate 72.

As the activation ring 60 is manipulated between the closed position 200 and the open position 202, and because the internal projections 64 are engaged with the locating feature notches 57 of the bearing retainer plate, thereby locking the activation ring 60 for rotational movement in concert with the bearing retainer plate 48, the bearing retainer plate 48 rotates relative to the lower lift plate 32. However, because the ball bearings 42 ride within bearing retainers 50 of the bearing retainer plate 48, the ball bearings 42 are caused to rotate in concert with the bearing retainer plate 48. Accordingly, as the bearing retainer plate 48 rotates relative to the lower lift plate 32, the ball bearings 42 ride within ramps 40 from the “heads” 44 to the “tails” 46 of the ramps 40. Since the ramps 40 and mirrored ramps 87 have a maximum depth at the “head” 44 and a minimum depth, smaller than the maximum depth, at the “tail” 46, as the bearing retainer plate 48 rotates relative to the lower lift plate 32, an axial distance between the lower carriage plate 72 and the lower lift plate 32 increases from a minimum distance when in the closed position 200 to a maximum distance greater than the minimum distance when in the open position 202. In several aspects, the maximum distance is substantially equal to a diameter of the ball bearings 42. Furthermore, since the lower carriage plate 72, first and second wire guide portions 90A, 90B, upper carriage plate 106, and washer 126 are axially linked or stacked together, all of the lower carriage plate 72, first and second wire guide portions 90A, 90B, upper carriage plate 106, and washer 126 move axially in concert with rotation of the bearing retainer plate 48. Thus, the first and second wire guide portions 90A, 90B and the wire guide cone tip 103 are axially movable relative to the mounting plate 16 and the crimping tool 14 such that when the wire guide cassette 12 is in the closed position 200, the wire guide cone tip 103 protrudes into the crimping tool 14, while when the wire guide cassette 12 is in the open position 202, the wire guide cone tip 103 is axially retracted from the crimping tool 14. Accordingly, in the open position 202, an end terminal 15 is freely movable relative to and may be inserted through the wire guide cassette 12 and into the crimping tool 14. The wire guide cassette 12 may then be moved to the closed position 200. In the closed position 200, axial movement of the wire 17 is allowed through the wire guide cassette 12 and into the crimping tool 14. Further, once a wire 17 has been inserted through the wire guide cassette 12 in the closed position 200, the wire 17 is axially guided by the first and second wire guide portions 90A, 90B towards and into the crimping tool 14 where the crimping tool 14 may be used to crimp the end terminal 15 onto a stripped end 17a of the wire 17. The stripped end 17a of the wire 17 is an end section of the wire 17 having any and all wire insulation removed so that the bare electrically-conductive core of the wire 17 is exposed. The wire guide cassette 12 may then be moved to the open position 202 and the crimping tool 14 may release the end terminal 15. In the open position 202, the wire 17 and end terminal 15 crimped thereon may be axially removed from the wire guide cassette 12 and crimping tool 14. Accordingly, it will be appreciated that the wire guide cassette 12 is actuatable between the closed position 200 and the open position 202 independent from movement of the crimping tool 14. That is, the crimping tool 14 is actuated to crimp the end terminal 15 onto the stripped end 17a of the wire in a motion independent from the motion of the wire guide cassette 12.

Since some of the rotational movement of the activation ring 60 is translated into axial movement of the wire first and second wire guide portions 90A, 90B, even though the activation ring 60 may rotate by the activation angle α of about 15°, the first and second wire guide portions 90A, 90B may rotate by an amount less than 15°. In a particular example, the first and second wire guide portions 90A, 90B may rotate for approximately 8° relative to the mounting plate 16 and crimping tool 14 as the activation ring 60 is manipulated from the closed position 200 to the open position 202.

A system and method for attaching electrical terminals to wires of the present disclosure offers several advantages. These include portability, hand-operability, rapid feed and tool portion changes that maintain proper alignment between the electrical terminals and the wire ends without sacrificing productivity and efficiency, and which decrease per-part costs.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for attaching electrical terminals to wires comprises:
a wire guide cassette; and
a crimping tool, wherein the wire guide cassette is removably mounted to the crimping tool, wherein the wire guide cassette is movable between at least a closed position and an open position displaced from the closed position, wherein the wire guide cassette is movable independent from crimping actuation of the crimping tool, wherein a wire inserted into the wire guide cassette in the closed position is located and guided into an end terminal held in the crimping tool, and the crimping tool is actuated to crimp the end terminal onto a stripped end of the wire, and wherein in the open position, the wire and end terminal are freely movable relative to and removable from the wire guide cassette and crimping tool.

2. The system of claim 1, wherein the wire guide cassette further comprises:
a mounting plate affixed coaxially to the crimping tool by one or more mounting plate fasteners;
a lower lift plate coaxially disposed overtop the mounting plate opposite the crimping tool;
one or more ball bearings disposed in ramps formed in the lower lift plate opposite the crimping tool;
a bearing retainer plate disposed overtop and coaxially located with the lower lift plate and the mounting plate, the bearing retainer plate movably retaining the one or more ball bearings;
a lower carriage plate coaxially disposed overtop the bearing retainer plate;
a plurality of wire guide portions disposed overtop the bearing retainer plate, the plurality of wire guide portions defining a wire guide cone tip extending coaxially through each of the lower carriage plate, the bearing retainer plate, the lower lift plate, the mounting plate, and into the crimping tool;
an upper carriage plate disposed overtop the plurality of wire guide portions, and located coaxially with the lower carriage plate, the bearing retainer plate, the lower lift plate, the mounting plate, and the crimping tool;
a washer disposed coaxially overtop the upper carriage plate;
a cover plate disposed coaxially overtop the upper carriage plate and secured to the upper carriage plate, the lower carriage plate, the bearing retainer plate, the lower lift plate and the mounting plate with one or more cover plate fasteners; and
an activation ring circumferentially surrounding at least the bearing retainer plate, the lower carriage plate, the one or more wire guide portions, and the upper carriage plate, wherein the activation ring is locked for rotational movement in concert with the bearing retainer plate, wherein as the activation ring is moved from the closed position to the open position, the activation ring causes rotational and axial movement of the bearing retainer plate, the lower carriage plate, the one or more wire guide portions, and the upper carriage plate relative to the mounting plate and the crimping tool, wherein the axial movement defines an increase in axial distance between the bearing retainer plate, the lower carriage plate, the one or more wire guide portions, and the upper carriage plate and the mounting plate and crimping tool.

3. The system of claim 2, wherein:
the ramps formed in the lower lift plate are substantially tear-drop shaped depressions having a variable depth which decreases from a substantially circular head to a pointed tail of the ramp, wherein the heads and tails of the ramps are circumferentially-disposed at equidistant locations about an outer surface of the lower lift plate, wherein the outer surface of the lower lift plate faces away from the mounting plate and the crimping tool;
the bearing retainer plate is disposed overtop the lower lift plate and movably retains the one or more ball bearings at the equidistant locations; and
the lower carriage plate has a plurality of mirrored ramps are formed on an inner side of the lower carriage plate at substantially identical circumferential positions as the ramps formed in the lower lift plate and bearing retainers formed through the bearing retainer plate, wherein the inner side of the lower carriage plate faces towards the mounting plate and the crimping tool; and wherein the mirrored ramps define substantially tear-drop shaped depressions having a variable depth which decreases from a substantially circular “head” to a pointed “tail” of the mirrored ramp; and
the mirrored bearing ramps are oriented opposite the ramps such that the heads and tails of the ramps extend in circumferentially opposite directions to the heads and tails of the mirrored ramps.

4. The system of claim 3, wherein the ramps and mirrored ramps have a maximum depth at the heads of the ramps and mirrored ramps, and a minimum depth, smaller than the maximum depth, at the tails of the ramps and mirrored ramps.

5. The system of claim 4, wherein as the activation ring is moved from the closed position to the open position, rotational movement of the activation ring causes rotational movement of the bearing retainer plate which thereby causes the ball bearings to ride within the ramps and mirrored ramps from the heads of the ramps and mirrored ramps to the tails of the ramps and mirrored ramps, thereby increasing an axial distance between the lower carriage plate and the lower lift plate from a minimum distance to a maximum distance larger than the minimum distance, wherein the maximum distance is substantially identical to a diameter of the ball bearings.

6. The system of claim 2, wherein the plurality of wire guide portions further comprise:
a first wire guide portion; and
a second wire guide portion identical to the first wire guide portion, wherein each of the first and second wire guide portions are rotatably attached to the upper and lower carriage plates by dowels extending from the lower carriage plate through the first and second wire guide portions and into the upper carriage plate, and wherein the first wire guide portion has a first diametric face, and the second wire guide portions has a second diametric face, wherein in the closed position, the first and second diametric faces are in contact with one another.

7. The system of claim 6, further comprising:
one or more return springs, the one or more return springs biasing the first and second diametric faces into contact with one another.

8. The system of claim 7, wherein each of the one or more return springs is in contact with and extends from an outer spring seat formed as an axial protrusion on the lower carriage plate to an inner spring seat formed on each of the first and second wire guide portions.

9. The system of claim 2, wherein the washer biases the cover plate against the upper carriage plate, thereby providing a compacting force that secures all component parts of the wire guide cassette against one another within the activation ring and against the crimping tool.

10. The system of claim 9, wherein the washer is formed of spring steel and defines a wave washer.

11. A wire guide system for hand tools, wherein the wire guide system comprises:
a wire guide cassette; and
a crimping tool, wherein a mounting plate of the wire guide cassette is removably and coaxially affixed to the crimping tool by one or more mounting plate fasteners, and wherein the wire guide cassette further comprises:
a mounting plate affixed coaxially to the crimping tool by one or more mounting plate fasteners;
a lower lift plate coaxially disposed overtop the mounting plate opposite the crimping tool;
one or more ball bearings disposed in ramps formed in the lower lift plate opposite the crimping tool;
a bearing retainer plate disposed overtop and coaxially located with the lower lift plate and the mounting plate, the bearing retainer plate movably retaining the one or more ball bearings;
a lower carriage plate coaxially disposed overtop the bearing retainer plate;
a plurality of wire guide portions disposed overtop the bearing retainer plate, the plurality of wire guide portions defining a wire guide cone tip extending coaxially through each of the lower carriage plate, the bearing retainer plate, the lower lift plate, the mounting plate, and into the crimping tool;
an upper carriage plate disposed overtop the plurality of wire guide portions, and located coaxially with the lower carriage plate, the bearing retainer plate, the lower lift plate, the mounting plate, and the crimping tool;
a washer disposed coaxially overtop the upper carriage plate;
a cover plate disposed coaxially overtop the upper carriage plate and secured to the upper carriage plate, the lower carriage plate, the bearing retainer plate, the lower lift plate and the mounting plate with one or more cover plate fasteners; and
an activation ring circumferentially surrounding at least the bearing retainer plate, the lower carriage plate, the one or more wire guide portions, and the upper carriage plate, wherein the activation ring is locked for rotational movement in concert with the bearing retainer plate, wherein as the activation ring is moved from a closed position to an open position, the activation ring causes rotational and axial movement of the bearing retainer plate, the lower carriage plate, the one or more wire guide portions, and the upper carriage plate relative to the mounting plate and the crimping tool, wherein the axial movement defines an increase in axial distance between the bearing retainer plate, the lower carriage plate, the one or more wire guide portions, and the upper carriage plate and the mounting plate and crimping tool; and wherein the wire guide cassette is movable, via actuation of the actuation ring, independent from crimping actuation of the crimping tool, wherein a wire inserted into the wire guide cassette in the closed position is located and guided into an end terminal held in the crimping tool, and the crimping tool is actuated to crimp the end terminal onto a stripped end of the wire, and wherein in the open position, the wire and end terminal are freely movable relative to and removable from the wire guide cassette and crimping tool.

12. The system of claim 11, wherein:
the ramps formed in the lower lift plate are substantially tear-drop shaped depressions having a variable depth which decreases from a substantially circular head to a pointed tail of the ramp, wherein the heads and tails of the ramps are circumferentially-disposed at equidistant locations about an outer surface of the lower lift plate, wherein the outer surface of the lower lift plate faces away from the mounting plate and the crimping tool;
the bearing retainer plate is disposed overtop the lower lift plate and movably retains the one or more ball bearings at the equidistant locations; and
the lower carriage plate has a plurality of mirrored ramps are formed on an inner side of the lower carriage plate at substantially identical circumferential positions as the ramps formed in the lower lift plate and bearing retainers formed through the bearing retainer plate, wherein the inner side of the lower carriage plate faces towards the mounting plate and the crimping tool; and wherein the mirrored ramps define substantially tear-drop shaped depressions having a variable depth which decreases from a substantially circular “head” to a pointed “tail” of the mirrored ramp;
the mirrored bearing ramps are oriented opposite the ramps such that the heads and tails of the ramps extend in circumferentially opposite directions to the heads and tails of the mirrored ramps; and wherein the ramps and mirrored ramps have a maximum depth at the heads of the ramps and mirrored ramps, and a minimum depth, smaller than the maximum depth, at the tails of the ramps and mirrored ramps.

13. The system of claim 12, wherein as the activation ring is moved from the closed position to the open position, rotational movement of the activation ring causes rotational movement of the bearing retainer plate which thereby causes the ball bearings to ride within the ramps and mirrored ramps from the heads of the ramps and mirrored ramps to the tails of the ramps and mirrored ramps, thereby increasing an axial distance between the lower carriage plate and the lower lift plate from a minimum distance to a maximum distance larger than the minimum distance, wherein the maximum distance is substantially identical to a diameter of the ball bearings.

14. The system of claim 11, wherein the plurality of wire guide portions further comprise:
a first wire guide portion; and
a second wire guide portion identical to the first wire guide portion, wherein each of the first and second wire guide portions are rotatably attached to the upper and lower carriage plates by dowels extending from the lower carriage plate through the first and second wire guide portions and into the upper carriage plate, and wherein the first wire guide portion has a first diametric face, and the second wire guide portions has a second diametric face, wherein in the closed position, the first and second diametric faces are in contact with one another.

15. The system of claim 14, further comprising:
one or more return springs, the one or more return springs biasing the first and second diametric faces into contact with one another so that wires inserted into the wire guide cassette in the closed position are located and guided into the end terminal held in the crimping tool.

16. The system of claim 15, wherein each of the one or more return springs is in contact with and extends from an outer spring seat formed as an axial protrusion on the lower carriage plate to an inner spring seat formed on each of the first and second wire guide portions.

17. The system of claim 11, wherein the washer biases the cover plate against the upper carriage plate, and provides a compacting force that secures all component parts of the wire guide cassette against one another within the activation ring and against the crimping tool.

18. A method for attaching electrical terminals to wires comprises:
removably mounting a wire guide cassette onto a crimping tool, wherein the wire guide cassette is movable between at least a closed position and an open position displaced from the closed position, wherein the wire guide cassette is movable independently from crimping actuation of the crimping tool;
inserting a wire into the wire guide cassette in the closed position, wherein in the closed position the wire is located and guided into an end terminal held in the crimping tool;
actuating the crimping tool to crimp the end terminal onto a stripped end of the wire; and
moving the wire guide cassette to the open position, wherein in the open position the wire and end terminal are freely movable relative to and removable from the wire guide cassette and crimping tool.

19. The method of claim 18 wherein removably mounting the wire guide cassette onto the crimping tool further comprises:
coaxially affixing a mounting plate of the wire guide cassette to the crimping tool with one or more mounting plate fasteners, wherein the wire guide cassette further includes:
a lower lift plate coaxially disposed overtop the mounting plate opposite the crimping tool;
one or more ball bearings disposed in ramps formed in the lower lift plate opposite the crimping tool, wherein the ramps formed in the lower lift plate are substantially tear-drop shaped depressions having a variable depth which decreases from a substantially circular head to a pointed tail of the ramp, wherein the heads and tails of the ramps are circumferentially-disposed at equidistant locations about an outer surface of the lower lift plate, wherein the outer surface of the lower lift plate faces away from the mounting plate and the crimping tool;
a bearing retainer plate disposed overtop and coaxially located with the lower lift plate and the mounting plate, the bearing retainer plate movably retaining the one or more ball bearings;
a lower carriage plate coaxially disposed overtop the bearing retainer plate, wherein a plurality of mirrored ramps are formed on an inner side of the lower carriage plate at substantially identical circumferential positions as the ramps formed in the lower lift plate and bearing retainers formed through the bearing retainer plate, wherein the inner side of the lower carriage plate faces towards the mounting plate and the crimping tool; and wherein the mirrored ramps define substantially tear-drop shaped depressions having a variable depth which decreases from a substantially circular “head” to a pointed “tail” of the mirrored ramp, wherein the mirrored bearing ramps are oriented opposite the ramps such that the heads and tails of the ramps extend in circumferentially opposite directions to the heads and tails of the mirrored ramps, wherein the ramps and mirrored ramps have a maximum depth at the heads of the ramps and mirrored ramps, and a minimum depth, smaller than the maximum depth, at the tails of the ramps and mirrored ramps;
a first wire guide portion and a second wire guide portion identical to the first wire guide portion, the first and second wire guide portions disposed overtop the bearing retainer plate, the first and second wire guide portions defining a wire guide cone tip extending coaxially through each of the lower carriage plate, the bearing retainer plate, the lower lift plate, the mounting plate, and into the crimping tool;
an upper carriage plate disposed overtop the first and second wire guide portions, and located coaxially with the lower carriage plate, the bearing retainer plate, the lower lift plate, the mounting plate, and the crimping tool, wherein each of the first and second wire guide portions are rotatably attached to the upper and lower carriage plates by dowels extending from the lower carriage plate through the first and second wire guide portions and into the upper carriage plate, and wherein the first wire guide portion has a first diametric face, and the second wire guide portion has a second diametric face, wherein in the closed position, the first and second diametric faces are in contact with one another;
a washer disposed coaxially overtop the upper carriage plate;
a cover plate disposed coaxially overtop the upper carriage plate and secured to the upper carriage plate, the lower carriage plate, the bearing retainer plate, the lower lift plate and the mounting plate with one or more cover plate fasteners; and
an activation ring circumferentially surrounding at least the bearing retainer plate, the lower carriage plate, the one or more wire guide portions, and the upper carriage plate, wherein the activation ring is locked for rotational movement in concert with the bearing retainer plate;
one or more return springs, wherein each of the one or more return springs is in contact with and extends from an outer spring seat formed as an axial protrusion on the lower carriage plate to an inner spring seat formed on each of the first and second wire guide portions; and
causing, by moving the activation ring, rotational movement of the bearing retainer plate and in turn, causing the ball bearings to ride within the ramps and mirrored ramps from the heads of the ramps and mirrored ramps to the tails of the ramps and mirrored ramps, thereby increasing an axial distance between the lower carriage plate and the lower lift plate from a minimum distance to a maximum distance larger than the minimum distance, wherein the maximum distance is substantially identical to a diameter of the ball bearings, wherein moving the activation ring from the closed position to the open position causes rotational and axial movement of the bearing retainer plate, the lower carriage plate, the one or more wire guide portions, and the upper carriage plate relative to the mounting plate and the crimping tool, wherein the axial movement defines an increase in axial distance between the bearing retainer plate, the lower carriage plate, the one or more wire guide portions, and the upper carriage plate and the mounting plate and crimping tool.

20. The method of claim 19 wherein
biasing, via the one or more return springs, the first and second diametric faces into contact with one another,
biasing, via the washer, the cover plate against the upper carriage plate, and providing a compacting force that secures all component parts of the wire guide cassette against one another within the activation ring and against the crimping tool.
